(19) United States
(12) Patent Application Publication
(10) Pub. No.: US 2007/0133678 A1
(43) Pub. Date: Jun. 14, 2007

(54) Information processing apparatus, control method and program

(76) Inventor: Ryuji Sakai, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/635,130

(22) Filed: Dec. 6, 2006

(30) Foreign Application Priority Data
Dec. 13, 2005 (JP) 2005-359359

(51) Int. Cl. H04N 11/04; H04B 1/66

(52) U.S. Cl. 375/240.03; 375/240.1

(57) ABSTRACT

According to one embodiment, when a plurality of video frames are encoded in parallel, a rate control is executed on the basis of the generated bit amount in the encoded video frames, and encoding the video frames and a rate control at a synchronization point 6-2 are executed in parallel.

### CROSS-REFERENCE TO RELATED APPLICATIONS

This application is based upon and claims the benefit of priority from Japanese Patent Application No. 2005-359359, filed Dec. 13, 2005, the entire contents of which are incorporated herein by reference.

### BACKGROUND

1. Field

This invention relates to encoding of video data using intra prediction and, more particularly, to an information processing apparatus, control method and program capable of encoding a plurality of video data items in parallel.

2. Description of the Related Art

In conventional video data encoding, video frames are sequentially encoded one by one and converted into a bit stream. At this time, a rate control of adjusting the bit amount of the currently encoded data on the basis of the previously encoded bit amount is conducted to synchronize the video frames to the bit rate of the encoded and output bit stream. As a technique of increasing the encoding processing rate, a technique of separating a video frame into an upper area and a lower area, conducting pipeline control for each of the areas and encoding one video frame is disclosed (Jpn. Pat. Appln. KOKAI Publication No. 8-265164).

According to the technique, however, pile line processing is conducted to encode the video frames in parallel, but optimizing the quantization parameter from the bit amount generated during encoding of each video frame is not conducted, and enhancing the image quality under the optimum rate control during encoding is difficult.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing a configuration of a notebook PC equipped with an information processing apparatus according to a first embodiment of the present invention;

FIG. 2 is a block diagram showing a configuration of a notebook PC;

FIG. 3 is a block diagram showing a configuration of H. 264;

FIG. 4 is an illustration of intra prediction;

FIG. 5 is an illustration of processing video frames by partition and processing video frames in sequence of raster;

FIG. 6 is an illustration of encoding a plurality of frames by parallel processing;

FIG. 7 is an illustration of encoded partition and non-encoded partition in one frame; and

FIG. 8 is a flowchart showing rate control provided as a control method equipped with the information processing apparatus of the present invention.

### DETAILED DESCRIPTION

Various embodiments according to the invention will be described hereinafter with reference to the accompanying drawings. In general, according to one embodiment of the invention, an information processing apparatus, encoding a plurality of video frames with intra prediction and outputting the plurality of encoded video frames. The apparatus comprises parallel encoding means for encoding the plurality of video frames in parallel, and rate control means for executing rate control in accordance with a generated bit amount in the video frames encoded by the parallel encoding means. The encoding of the video frames by the parallel encoding means is executed parallel with the rate control executed by the rate control means.

An embodiment of the present invention will be explained below with reference to the accompanying drawings.

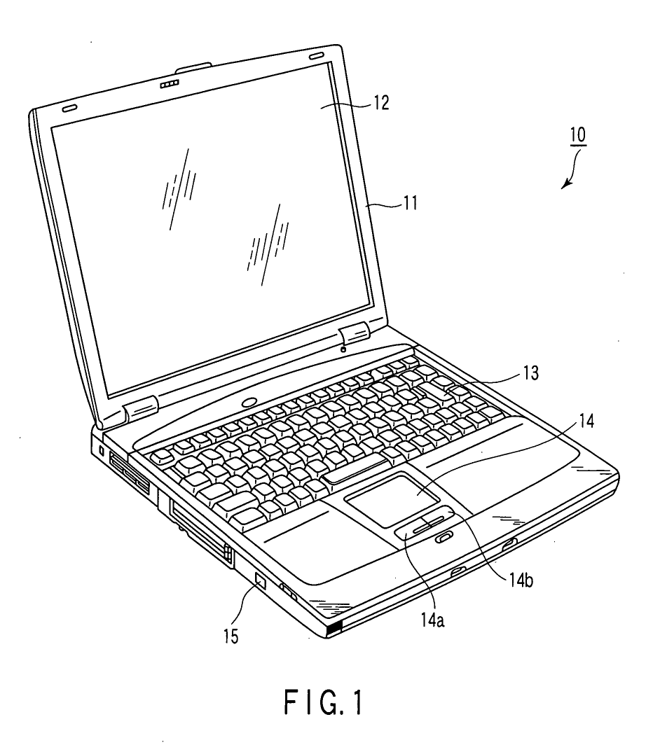

FIG. 1 shows a system configuration of an information processing apparatus according to an embodiment of the present invention. The information processing apparatus is implemented as a battery-operated notebook computer 10. In the embodiment of the present invention, the generated bit amount is calculated during the parallel encoding and a quantization parameter is determined to conduct the rate control while encoding parallel the input video frames.

The computer 10 is composed of a computer body and a display unit 11 as shown in FIG. 1. A display device composed of an LCD (Liquid Crystal Display) is embedded in the display unit 11. A display screen 12 of the LCD is located approximately at the center of the display unit 11.

The display unit 11 is attached to the computer 10 so as to freely pivot between an opened position and a closed position. The main body of the computer 10 has a housing shaped in a thin box, and comprises a keyboard 13 on a top face, a touch pad 14 and two buttons 14a, 14b on a palm rest, an optical drive unit 15 on a side face, etc.

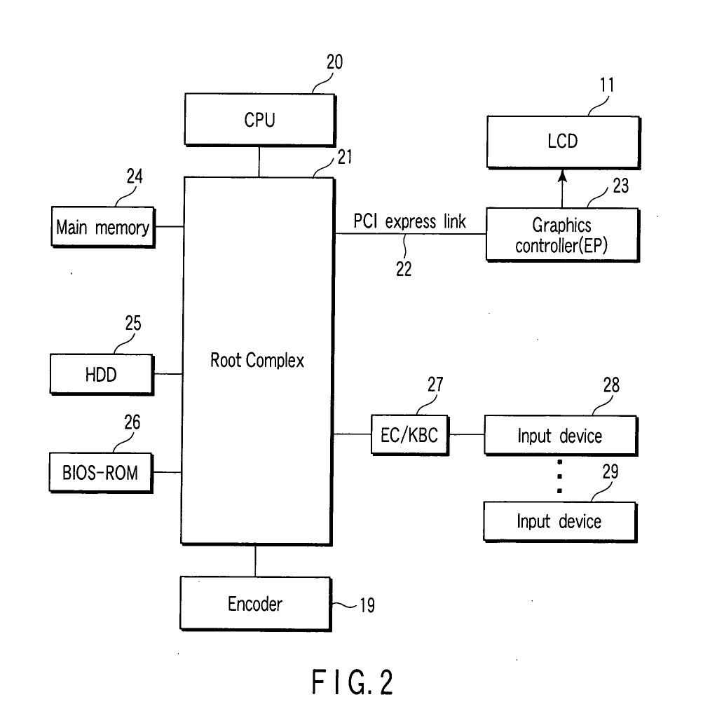

FIG. 2 is a block diagram showing the configuration of the computer 10.

The computer 10 comprises a CPU (Central Processing Unit) 20, a Root Complex 21, a main memory 24, a graphics controller (End Point) 23, a PCI Express Link 22 making a connection between the Root Complex 21 and the graphics controller 23, the display unit 11, an embedded controller/keyboard controller IC (EC/KBC) 27, a hard disk drive (HDD) 25, a BIOS-ROM 26, input devices 28, 29 connected to the EC/KBC 27, an encoder 19 which encodes image data such as video data, etc.

The encoder 19 is, for example, an H. 264 video encoder, which encodes the video frames.

The Root Complex 21, the graphics controller 23, etc. are devices in conformity with the PCI EXPRESS standards. The communications between the Root Complex 21 and the graphics controller 23 are executed over the PCI Express Link 22 located between the Root Complex 21 and the graphics controller 23.

The CPU 20 is a processor controlling the operations of the computer, executing various kinds of programs (operating system and application systems) loaded on the main memory 24 by the HDD 25. In addition, the CPU 20 also executes the BIOS (Basic Input Output System) stored in the BIOS-ROM 26. The BIOS is a program for controlling the hardware.

The Root Complex 21 is a bridge device making a connection between a local bus of the CPU 20 and the graphics controller 23. In addition, the Root Complex 21 also has a function of executing the communications with the graphics controller 23 over the PCI Express Link 22.

The graphics controller 23 is a display controller which controls the display unit 11 employed as a display monitor of the computer.

The EC/KBC 27 is a one-chip microcomputer on which an embedded controller for power management and a keyboard controller controlling the keyboard (KB) 13 and the touch pad 14 are integrated. The EC/KBC 27 has a function of controlling power-on/power-off of the computer 10, in cooperation with a power supply controller, in response to the user's operation of the power button.

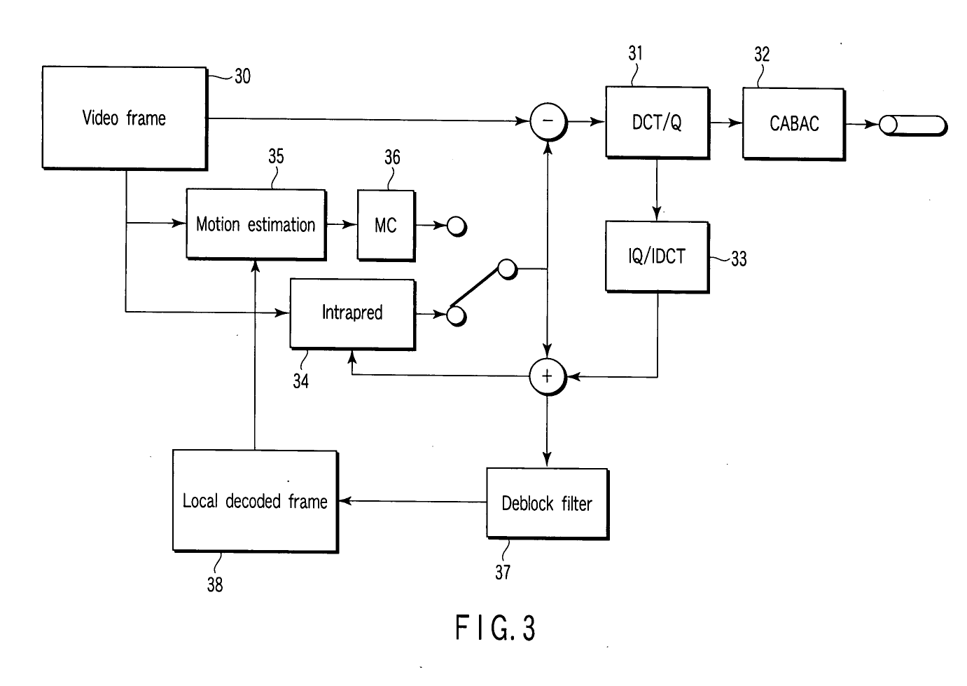

FIG. 3 shows a configuration of the encoder 19.

The encoder 19 comprises integer converting/quantizing means (DCT/Q) 31 for conducting integer conversion/quantization of an input video frame (Video Frame) 30, entropy encoding means (CABAC) 32 for conducting entropy encoding, de-quantizing/integer de-converting means (IQ/IDCT) 33 for converting de-quantization and integer de-conversion, intra-prediction means (IntraPre) 34 for conducting intra-prediction of the video frame, estimation means (Motion Estimation) 35 for conduction motion estimation of the video frame, motion compensation means (Motion Compensation) 36 for conducting of the motion compensation of the video frame, a deblocking filter (Deblock Filter) 37 which converts a voltage into a frequency, frame storing means (Local Decoded Frame) 38 for storing the video frame.

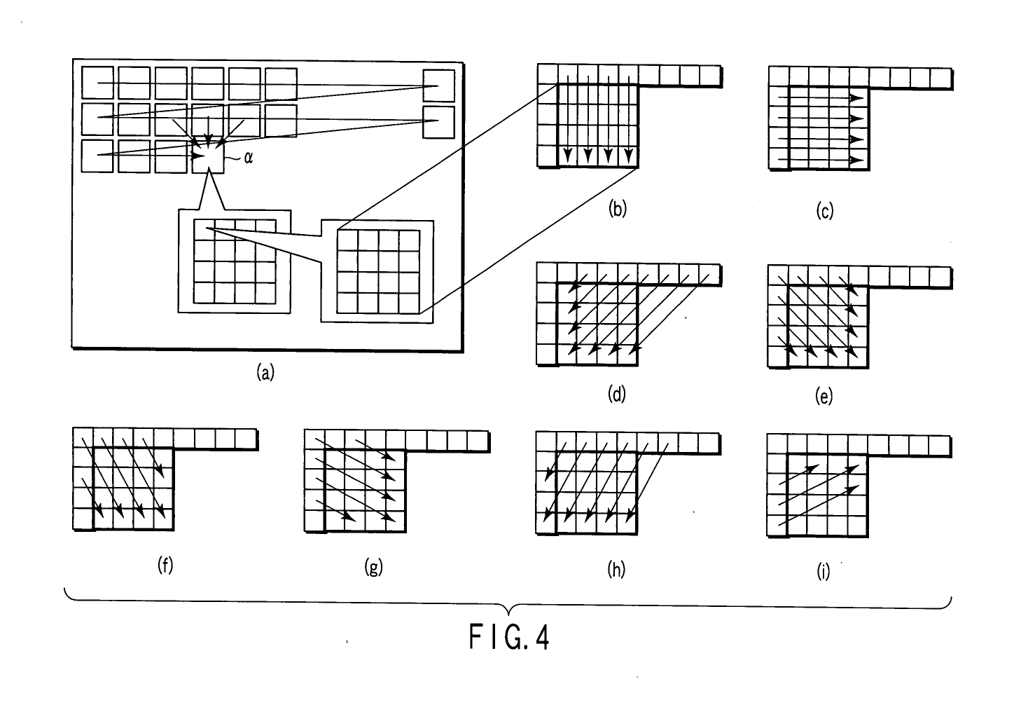

The intra-prediction is a technique by which to estimate a pixel to be encoded, a value of an encoded pixel α of a peripheral portion of the pixel (refer to FIG. 4(a)). “α” is calculated the value from the value of the around pixel.

There are various modes of the intra-prediction as shown in FIGS. 4(b) to 4(i). To use the encoded peripheral pixel, encoding one frame needs to be conducted by maintaining the raster sequence.

One of processing units of the video encoding/decoding is called a slice. As the video codec standard, the intra-prediction across the processing unit called slice cannot be conducted. In other words, the video frames can be encoded in parallel by dividing the video frame into slices. However, when the video frame is divided into a plurality of slices, the intra-prediction cannot be conducted at each boundary of the slices and the compression rate of the video data is thereby deteriorated.

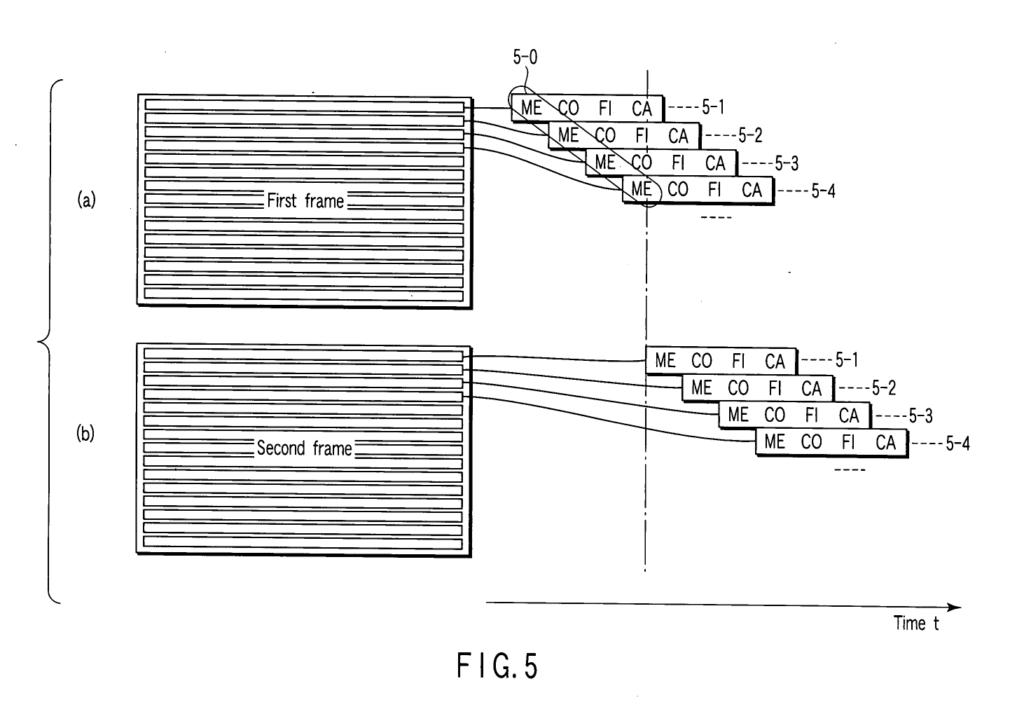

For this reason, the video frame is divided into a plurality of processing units that are not slices. In this embodiment, the video frame is divided into units called partitions. To allow the intra-prediction to be conducted across the partitions, the processing of partitions is conducted in the raster sequence. Steps of this processing are shown in FIG. 5.

As shown in FIG. 5, adjacent two video frames, of a plurality of video frames, are referred to as a first frame and a second frame. Each of the frames is divided into partitions. The frame is divided laterally in FIG. 5. The partitions are encoded in parallel by using pipeline processing. For example, when processing 5-1 of the first partition of the first frame is conducted and ME: MotionEstimation of the processing 5-1 is conducted, then processing 5-2 of the second partition of the first frame is conducted.

CO represents a phase of coding (Coding) of conducting mode discrimination, quantization and transform, FI represents a phase of conducting deblock filter (DeblockFilter), and CA represents a phase of conducting context application type arithmetic encoding (Cabac).

As described above, encoding is conducted in partitions in each of the frames. When the FI processing of the first frame is terminated, ME processing can be started as the encoding of the second frame immediately without waiting for completion of the encoding of the first frame.

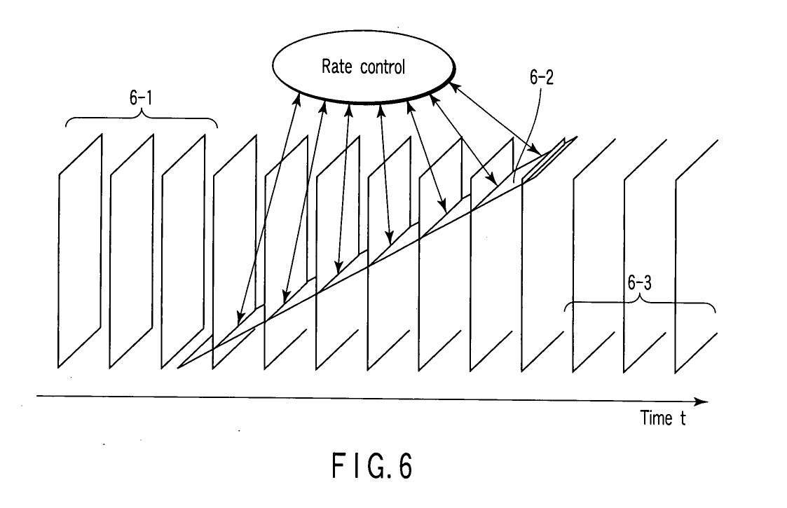

For this reason, in a system capable of using a plurality of processors, a plurality of frames can be encoded in parallel at a small time interval (similarly to, for example, processing 5-0 of conducting the ME processing in parallel) (FIG. 5 and FIG. 6). Certainly, even in a single-processor system, a plurality of frames can be processed in parallel, apparently by time division, by activating a plurality of threads. In the parallel processing, a synchronization point for conducting the processing simultaneously is set. For example, in the processing 5-1 and the processing 5-2, CO processing and ME processing are conducted as a synchronization point for conducting the processings simultaneously. In the processing 5-1, the processing 5-2 and the processing 5-3, FI processing, CO processing and ME processing are conducted as a synchronization point for conducting the processings simultaneously. For example, in the processing 5-1 to the processing 5-4, CA processing, FI processing, CO processing and ME processing are conducted as a synchronization point for conducting the processings simultaneously.

Next, FIG. 6 is an illustration showing a concept of encoding using the parallel processing of a plurality of frames.

In FIG. 6, encoding first three frames 6-1 have been completed, and following seven frames are simultaneously encoded. (Further following three frames are not encoded at all.) Each frame is composed of a plurality of partitions. The partitions are encoded from the upper side to the lower side of each frame. Synchronization point 6-2 of each of the encoded frames is represented as a face.

At the synchronization point 6-2, optimum rate control is executed and the generated bit amount in each frame is adjusted.

The adjustment of the generated bit amount is conducted by increasing or decreasing the value QP (quantization parameter) of a quantizing step. If QP is greater, the amount of generated bits can be decreased but the image quality is degraded. If QP is smaller, the generated bit amount can be increased but the image quality is enhanced.

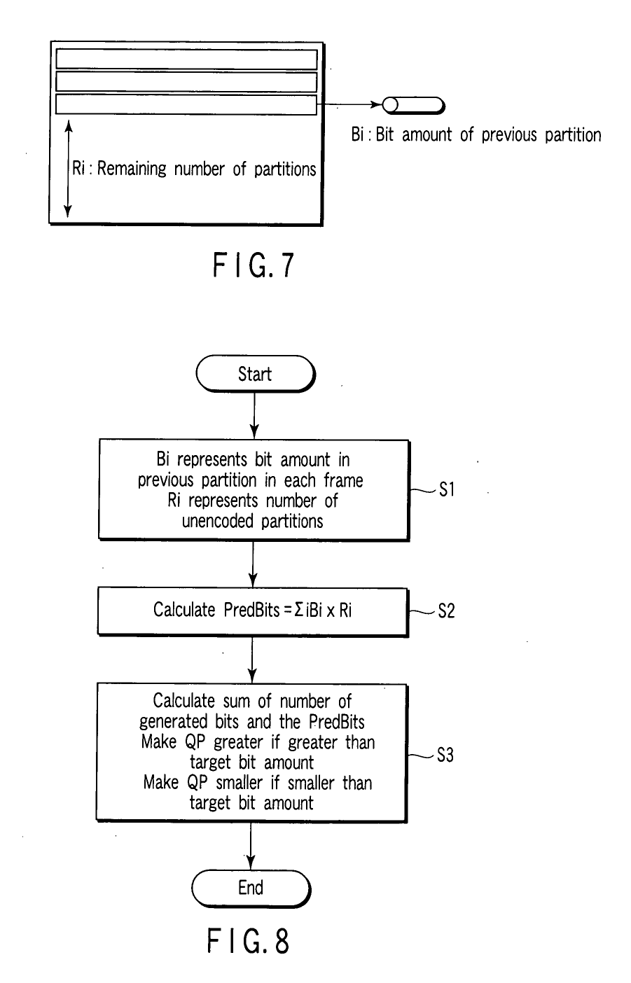

FIG. 7 is an illustration of encoded partitions and unencoded partitions in one frame. A generated bit amount of encoded partitions is represented by Bi and the number of unencoded partitions is represented by Ri.

Next, FIG. 8 is a flowchart of rate control as a control method using the information processing apparatus of the present invention.

First, the CPU 20 sets a desired bit amount obtained after encoding the video frames as a target bit amount. Furthermore, the CPU 20 inputs the generated bit amount Bi of each frame, and the number Ri of remaining partitions, at each of the synchronization points (step S1).

Next, the CPU 20 calculates and estimates the generated bit amount in the remaining partitions in each frame, in the following formula (step S2).
PredBits=ΣiBi*Ri (1)

At the synchronization points, the CPU 20 calculates a sum of the generated bit amount Bi and the above PredBits, and compares the sum with the above target bit amount. If the sum is greater than the target bit amount, the CPU 20 decreases the generated bit amount by making the QP greater. If the sum is smaller than the target bit amount, the CPU 20 makes the QP smaller (step S3).

Thus, when the video frames are encoded in parallel, it is possible to conduct a control of optimizing the quantization parameter on the basis of the bit amount generated during encoding each of the video frames, increase the generated bits and enhance the image quality. For this reason, the rate control in a 1-pass video encoder can be conducted more stably. Even at the encoding of radically varied video contents, disturbance of images resulting from the rate control can be reduced.

### MODIFIED EXAMPLE

As a modified example of the above embodiment, the QP may be controlled to be the same for all the video frames.

Furthermore, the QP of the frame which can be a reference frame may be controlled to be smaller by, for example, 1 to 3 than that of the frame which cannot be the reference frame.

In the above embodiment, estimation of the generated bit amount is calculated on the basis of the generated bit amount at the previous partition. However, the estimating method can also be conducted by estimating the generated bit amount with reference to the generated bit amount at second or further previous partition, or by analyzing characteristics of data to be encoded. For example, in a case where it can be discriminated that there are little movements from the size of the encoded motion vector, an estimated value of the generated bit amount can be corrected on the basis of the encoding amount of the partition at the same location in the previous frame.

In the above embodiment, a case of B picture is not shown. In the case of B picture, however, simultaneous processing of a plurality of frames can be implemented in accordance with the frame reference and dependency in the ME processing, and the rate control can be conducted in the same method as the above-described method.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, encoding a plurality of video frames with intra prediction and outputting the plurality of encoded video frames,
the apparatus comprising:
parallel encoding means for encoding the plurality of video frames in parallel; and
rate control means for executing rate control in accordance with a generated bit amount in the video frames encoded by the parallel encoding means,
the encoding of the video frames by the parallel encoding means being executed parallel with the rate control executed by the rate control means.

2. The apparatus according to claim 1, wherein the rate control means controls a quantization parameter in accordance with the generated bit amount in the video frames in the encoding executed by the parallel encoding means.

3. The apparatus according to claim 1, wherein the parallel encoding means separates the video frames into a plurality of partitions and executes parallel encoding for each partition.

4. The apparatus according to any one of claim 1, wherein a desired bit amount generated by encoding the plurality of video frames is set as a target bit amount, and
at an arbitrary time during the parallel encoding of the plurality of video frames by the parallel encoding means, the rate control means,
the rate control means sets the generated bit amount in a case of encoding an amount of unencoded partitions in each of the video frames as a first generated bit amount and sets the encoded generated bit amount in each of the video frames as a second generated bit amount, and
the rate control means executes the control to make the quantization parameter greater if a sum of the first generated bit amount and the second generated bit amount is greater than the target bit amount, and executes the control to make the quantization parameter smaller if a sum of the first generated bit amount and the second generated bit amount is smaller than the target bit amount.

5. The apparatus according to claim 1, wherein the rate control means executes the rate control in accordance with the generated bit amount for at least one arbitrary video frame, of the plurality of video frames encoded by the parallel encoding means.

6. A method of controlling an information processing apparatus encoding a plurality of video frames with intra prediction and outputting the plurality of encoded video frames,
the method comprising:
parallel encoding the plurality of video frames; and
executing a rate control in accordance with an amount of generated bits in the video frames encoded by the parallel encoding, simultaneously with the parallel encoding.

7. The method according to claim 6, wherein the rate control controls a quantization parameter in accordance with the generated bit amount in the video frames in the encoding executed by the parallel encoding.

8. The method according to claim 6, wherein the parallel encoding separates the video frames into a plurality of partitions and executes parallel encoding for each partition.

9. A program employed in an information reading apparatus encoding a plurality of video frames with intra prediction and outputting the plurality of encoded video frames,
the program allowing the computer to execute
a parallel encoding procedure to encode the plurality of video frames in parallel; and
a rate control procedure to execute a rate control in accordance with a generated bit amount in the video frames encoded by the parallel encoding, simultaneously with the parallel encoding procedure.

10. The program according to claim 9, wherein the rate control procedure controls a quantization parameter in accordance with the generated bit amount in the video frames in the encoding executed by the parallel encoding procedure.
